(19) United States
(12) Patent Application Publication
(10) Pub. No.: US 2014/0230571 A1
(43) Pub. Date: Aug. 21, 2014

(54) APPARATUS TO MEASURE THE POWER EXPENDED IN PROPELLING A VESSEL ON WATER

(71) Applicant: VELOCOMP, LLC., BOCA RATON, FL (US)

(72) Inventors: TRAVIS PAPE, DURHAM, NC (US); JOHN HAMANN, GULF STREAM, FL (US)

(73) Assignee: VELOCOMP, LLC., BOCA RATON, FL (US)

(21) Appl. No.: 14/262,721

(22) Filed: Apr. 26, 2014

Related U.S. Application Data
(63) Continuation of application No. 13/615,571, filed on Sep. 13, 2012.
Application No. 13/615,571 is a division of application No. 12/715,391, filed on Mar. 2, 2010, now abandoned.

(51) Int. Cl. G01M 10/00

(52) U.S. Cl. CPC G01M 10/00
USPC 73/862.381

(57) ABSTRACT

An apparatus is disclosed comprising a suite of sensors for measuring instant static and dynamic pressure, speed of the water flowing past the vessel in the direction of travel of the vessel, acceleration of the vessel in the direction of motion, and position of a vessel, such as a row boat. A microprocessor receives data from the sensors and calculates power expended by the rower, paddler, or other human or non-human power source by finding the total of all forces impinging upon the vessel and passengers, thereafter multiplying by the speed of the water flowing past the vessel in the direction of travel of the vessel. In one embodiment data is stored for later analysis or for downloading to a computer or other data storage device.

### CROSS REFERENCE TO RELATED APPLICATIONS

This application is a Continuation of the commonly owned U.S. patent application Ser. No. 13/615,571 filed Sep. 13, 2012 by Travis Pape et al which is incorporated by reference in its entirety. Application Ser. No. 13/615,571 is a Divisional application of commonly owned U.S. patent application Ser. No. 12/715,391 filed Mar. 2, 2010, which is incorporated by reference in its entirety. Priority to both is hereby claimed to the extend allowed by law.

### BACKGROUND

In sports training, it is desirable to measure performance indications of an athlete, such as the power produced and the total energy expended. As athlete training continues to become more and more sophisticated, some training is conducted indoors under controlled conditions, where typically large or stationary equipment is used. However many athletes and trainers prefer to monitor performance in real time under actual conditions. In rowing, some products measure rowing stroke cadence, power output and energy expended by direct or indirect measurements of the forces that the rower is applying to drive a vessel forward. Examples include mechanical strain gauges installed in an oarlock to measure the applied forces and, when combined with a measurement of the vessel speed, calculates power and energy. Such equipment is complex to install and expensive. Additionally, the same apparatus and equipment that can determine the power provided by a human may also be applied to powered vessels, for example power boats and sail boats.

### SUMMARY

The disclosure of the present invention describes a novel approach to the determination of the amount of power produced and energy expended by a person or persons in propelling a water-going vessel, for example by rowing, sculling, or paddling or by a non-human power source such as an engine/propeller or sail. The term “vessel” will be used throughout the instant disclosure, and refers to at least a rowing shell, paddle boat, dragon boat, row boat, canoe, kayak, power boat, sail boat and other human-powered and non-human powered water craft. The present invention determines the forces that oppose the motion of the vessel, any forces that aid in the motion of the vessel (such as a tail wind or water current), and determines the net resistive forces which must be overcome by the rowing motion. According to Newton's Third Law, the sum of these forces is equal and opposite to the force applied by the rower. These opposing forces comprise water skin drag, aerodynamic drag, and inertia.

To determine the various forces which oppose movement of the vessel, the present invention provides a suite of sensors for obtaining data, the sensors mounted within a case on a vessel, facing the direction of motion. An accelerometer provides data related to changes in velocity. One or more differential pressure sensors provide data on the aerodynamic pressure applied against the front, back, or sides of the vessel and its occupants, thereby to calculate the net opposing or aiding aerodynamic force. Barometric pressure and air temperature values are used to estimate air density. Due to the relatively slow speed of a vessel, and given that wind may sometimes push forward from the rear of the vessel rather than pushing back from the front, some embodiments include a second set of sensors facing directly away from the first set of sensors.

A sensor for measuring the velocity of the vessel through the water provides a value for calculating the drag due to water skin resistance, water form resistance, and other sources of energy loss in water such as wake formation that are functions of speed relative to the water surface. One example of a device for measuring vessel speed through the water is a hull-mounted impeller, for example an impeller available from Nielson-Kellerman, 21 Creek Circle, Boothwyn, Pa., 19061. Sensors based upon other technologies may be used, for example Doppler radar, digital imaging, sonar, and GPS.

In some embodiments the calculations to derive forces from acceleration and wind pressure information are improved by input from the user or through calibration procedures. For example, the acceleration data is combined with the known or assumed total weight of the vessel and occupants to determine the force due to acceleration (vessel+occupant acceleration). Aerodynamic forces are calculated from aerodynamic pressure measurements combined with aerodynamic drag and area terms, which in some embodiments are improved by measurements from a coast-down procedure. Drag forces may be estimated, assumed, entered by a user, or measured by a coast-down calibration or other calibration procedures.

Since water skin drag and aerodynamic drag act on the vessel simultaneously, in some embodiments the magnitude of the two factors is determined using a calibration procedure denominated a “blow back procedure”. In this procedure, the vessel and occupants are allowed to be blown backwards by the wind until they reach a steady-state velocity relative to the water. By measuring the water speed and air speed, together with a previous measurement or estimate of the vessel's water skin drag as determined by a coast down procedure, the aerodynamic drag coefficient can be calculated. After completion of the blow back calibration, another coast down calibration is performed, using the measured value of aerodynamic drag, thereby to determine a refined value of water skin drag. With this refined value of water skin drag, another blow back calibration is performed, iteratively, until the values of water skin drag and aerodynamic drag stabilize. The coast-down procedure can then be done again with the refined value of aerodynamic drag iteratively improving the measurements of the drag coefficients with each additional calibration cycle.

In other embodiments, the coast-downs are performed both into a head wind and then with a tail wind providing data that again can separate the action of the aerodynamic resistance from the water skin resistance. Using this method, both the skin drag coefficient and the aerodynamic drag coefficient are calculated simultaneously by fitting the combined data to the appropriately reduced equation of motion. Since the fitting is done on data where (1) water drag and air drag both slow the vessel and (2) wind aids the vessel motion and only water drag slows it down, the method provides an improved method for accurately calculating the water skin drag coefficient and the aerodynamic drag coefficient and separating the contribution of each to the resistance of vessel motion.

In another embodiment, a vessel whose drag coefficient is to be measured is attached to another vessel and is towed through the water at a steady rate typical of the subject vessel. A strain gauge or other force measuring device is used to determine the total force required to pull the subject vessel forward at the desired speed. Once this force is determined it is a straightforward process to calculate the hull drag of the target vessel.

In one embodiment these procedures are used in the same manner to determine the various parameters regarding a power boat, thereby enabling the same apparatus and methods to be used in determining the power delivered by the engine without monitoring the engine itself. Similarly, applying the same apparatus and methods to a sail boat determines the power provided by the sail to the boat.

The sensors described by the instant disclosure are used by a microcomputer, which in turn calculates certain performance and status information. The results are presented to the user, and/or may be recorded for later analysis.

### BRIEF DESCRIPTION OF THE DRAWINGS

FIG. 1 is a top level schematic, indicating the connections between major functional blocks of one embodiment of the invention.

FIG. 2 is a schematic showing connections to a microcontroller in the present invention.

FIG. 3 is a schematic of a module which provides signals related to acceleration of a vessel.

FIG. 4 is a schematic of a circuit providing bias voltages for a liquid crystal display device.

FIG. 5 is a schematic of an interface to a liquid crystal display device.

FIG. 6 is a schematic of a module which provides signals related to absolute pressure.

FIG. 7 is a schematic of a module which provides signals related to differential pressure.

FIG. 8 is a schematic of a battery supply to the system of the invention.

FIG. 9 is a schematic of connections to a microcontroller in another embodiment of the invention.

FIG. 10 is a schematic of a module which provides signals related to acceleration of a vessel.

FIG. 11 is a top level schematic, indicating the connections between major functional blocks of one embodiment of the invention.

FIG. 12 is a schematic of a module which provides signals related to absolute pressure.

FIG. 13 is a schematic of a module which provides signals related to differential pressure.

FIG. 14 is a schematic of a module which amplifies and filters differential signals.

FIG. 15 is a schematic of a JTAG interface to an MCU.

FIG. 16 is a schematic of a nonvolatile storage system.

FIG. 17 is a schematic of a serial communications interface to an MCU.

FIG. 18 is a top level flow chart of a method according to the present invention.

FIG. 19 is a top level flow chart of a calibration procedure.

### DESCRIPTION OF SOME EMBODIMENTS

Table 1 provides some Acronyms, and Abbreviations as may be used in the detailed description.

TABLE 1

| | |
|---|---|
| ADC | Analog to digital converter |
| AVCC | Positive DC voltage supplied to analog components |
| GPS | Global Positioning System. A technology which provides |
| | location and certain other data based upon received satellite |
| | signals. |
| LCD | Liquid crystal display |
| MCU | Microcontroller or microprocessor |
| MEMS | Micro-electro-mechanical system integrated circuit |
| MUX | Multiplexer |
| VCC | Positive DC voltage supplied to digital components |
| Pt | Total pressure |
| Ps | Static pressure |
| Q | Dynamic pressure; (Pt − Ps) |
| R | Gas constant: .286 KJ/kg/degree Kelvin |
| G or g | Symbol for acceleration, wherein one G is defined as the |
| | gravitational pull of the earth at the equator. |
| ρ | Density of air; =Ps/(RT) |
| T | Absolute temperature (degrees Kelvin) |
| V or v | Vessel velocity, Subscripts may refer to a reference, such as |
| | ground, air, or water surface. |

The present invention is described as implemented on a water vessel, such as a rowing shell, but it may be practiced on any water-going vessel. The term “vessel” as used throughout this disclosure may include the human(s) that is using the vessel device. For example, the drag coefficient of a vessel would include the effect of the person(s) propelling or riding in the vessel.

The present invention comprises sensors to measure vessel speed relative to a body of water, acceleration, air temperature, absolute and differential ambient air pressure facing one or more directions, an MCU to control system operation and to collect and process sensor data, an optional display of user information or instructions, switches to accept user control inputs, and electrical DC power for circuit and sensor operation. In another embodiment a GPS sensor is used to determine vessel position and speed of the vessel with respect to the land.

This disclosure describes an embodiment of the present invention wherein all of the described modules are employed. This description should not be considered limiting, in that the invention encompasses subset embodiments wherein some features, accuracy, or both may be diminished for cost or other reasons. For example, some embodiments do not include a second set of sensors. Others will be obvious to one skilled in the relevant art. All such embodiments are practice of the present invention.

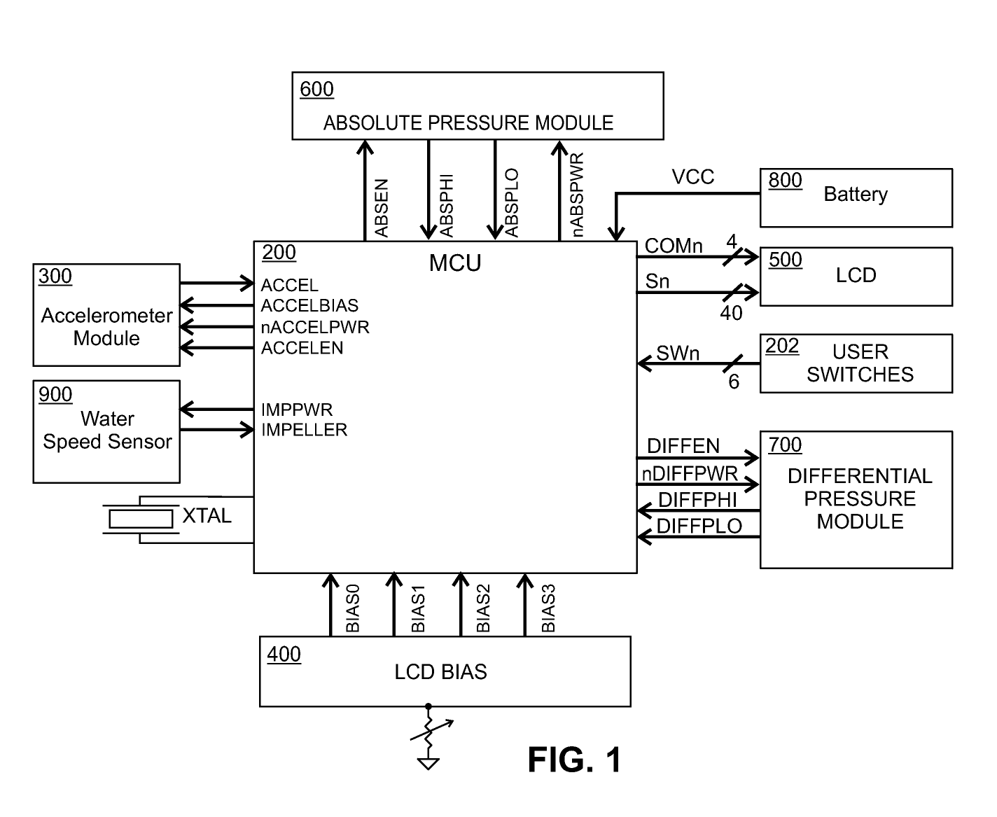

Connections between the functional blocks comprising one embodiment of the invention are shown in FIG. 1. In one embodiment MCU 200 is a low-power microcontroller with an integrated multiplexed ADC and a display controller, for example an LCD driver/controller. In some embodiments the ADC provides 12-bit resolution. Input ports on the MCU 200 accept inputs from switches, sensors with contact-closure outputs which provide timing signals, and sensors with analog outputs related to air pressure and acceleration. Timer functions associated with some input ports are used to debounce switch and contact closure inputs and to calculate rotation rates of a water speed sensor 900, for example an impeller. The MCU 200 selectively enables or disables sensors and/or the LCD display 500 to reduce power consumption and extend battery life. In some embodiments the MCU 200 also includes an internal temperature sensor and supply voltage sensor. In one embodiment a temperature reading is used to correct sensor readings which can drift with temperature changes and for estimating air density.

There are many MCUs in the industry that are suitable for practicing the invention. Alternatives may include more or fewer on-chip functions. MCU 200 described herein is for illustrative purposes. One skilled in the art will understand that some functions and features ascribed to the MCU 200 may be implemented with a different system partitioning of on or off chip, such as an external ADC, external MUX, and external temperature sensor. The embodiment described herein is representative of a certain complement of features and functions. The present invention includes alternative embodiments that incorporate more or fewer end-user features.

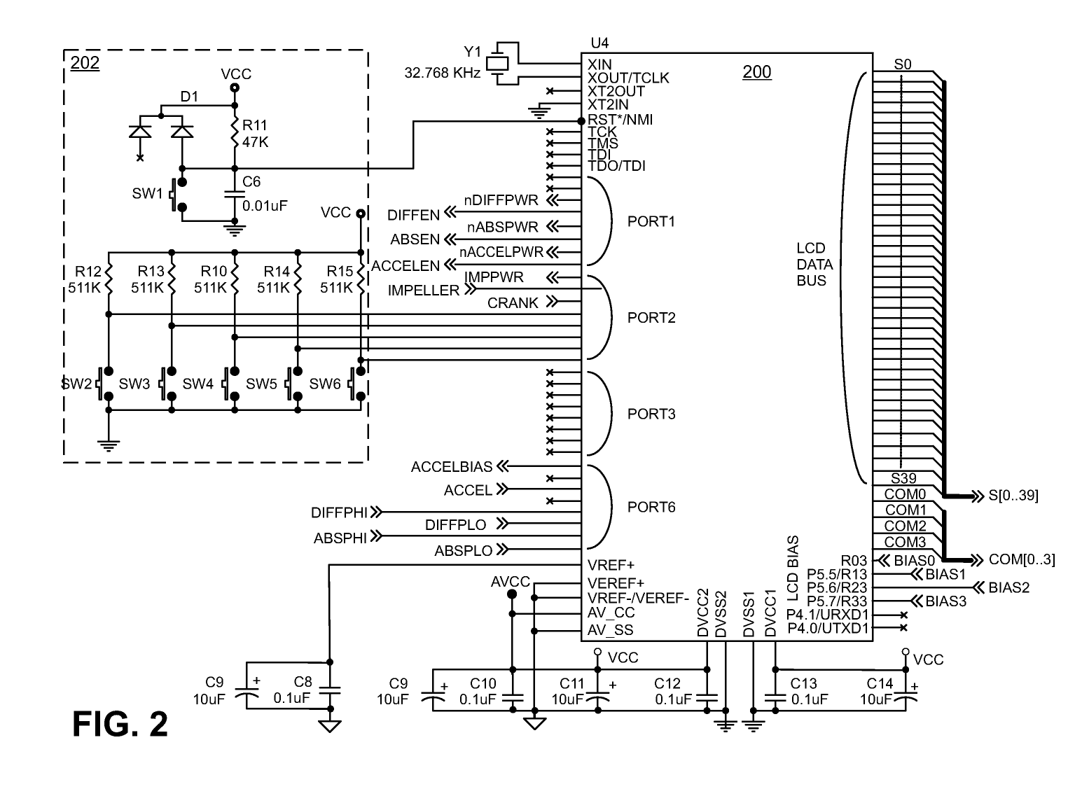

FIG. 2 details connections to the MCU 200. Lines S0 to S39 provide LCD segment output drive signals to segment input lines on LCD 500. Lines COM0 to COM3 connect with the common (backplane) input lines on LCD 500. Lines BIAS0 to BIAS3 provide various voltages needed to generate the segment and common signals to the LCD 500. Other displays may have more or fewer segment and common signals. Other display technologies, such as LED, may also be utilized instead of LCD 500. In one embodiment certain words and symbols are printed on the case and one or more LEDs or LCD segments are used to indicate a certain word or symbol. In one embodiment crystal Y1 provides a 32,768 Hz time base from which all MCU 200 system dock and timing functions are derived.

User switches SW1 through SW6 202 provide for command input and system reset by the user. Switch SW1, diode D1, resistor R11, and capacitor C6 provide a reset network. Application of battery voltage to terminal VCC or closure of switch SW1 asserts line RST*, forcing the MCU 200 to reset and restart. The values of resistor R11 and capacitor C6 are selected to achieve the desired duration of reset pulse width in accordance with the specification of a selected MCU. A typical keypad input arrangement for user interface is connected to port 2. The MCU 200 periodically reads port 2 terminal logic states to execute a system function associated with a depressed switch. If available, input interrupt circuits in the MCU 200 may detect changes in the switch states and alert the processor. FIG. 2 is an example of one system design and partitioning and is for illustration purposes, not as a limitation to practice of the invention.

In some embodiments power consumption is minimized by selectively powering various portions of the system only when needed. In the example shown the differential pressure module 700 is powered in response to signal nDIFFPWR, the absolute pressure module 600 is powered in response to signal nABSPWR, and the accelerometer module 300 is powered in response to signal nACCELPWR, and the water speed 900 sensor is powered in response to signal IMPPWR.

The MCU 200 asserts signal DIFFEN to enable differential pressure module 700 differential amplifier 702 and releases signal DIFFEN to place differential amplifier 702 in low-power mode. Lines DIFFPHI and DIFFPLO are connected to the ADC MUX of the MCU 200.

The absolute pressure module 600 provides absolute pressure measurements for air density and altitude calculations. The MCU 200 asserts signal ABSEN to enable absolute pressure module 600 differential amplifier 602 and releases ABSEN to place differential amplifier 602 in low power mode. Lines ABSPHI and ABSPHLO are connected to the ADC MUX of the MCU 200.

The MCU 200 asserts signal ACCELEN to enable acceleration module amplifier U2A 302 and releases ACCELEN to place amplifier U2A 302 in low power mode. Signal ACCELBIAS, under the control of the MCU 200 as described later, controls the bias to amplifier U2A 302. Line ACCEL from accelerometer module 300 is connected to the ADC MUX of the MCU 200.

Line IMPELLER provides contact closure pulse signals responsive to an impeller 900 (in this example) rotation sensor to a digital input of the MCU 200. The MCU 200 measures the time between pulses to calculate vessel speed relative to the water. The speed of the vessel through the water is used for power calculations:

Power=(Vessel speed through the water)*(sum of opposing forces).

In another embodiment, ground speed calculations are used by the MCU 200 to provide information to the occupants regarding the progress of the vessel towards a stationary, earth-bound target. In some embodiments position data is provide by a module, such as a GPS satellite module (not shown). FIG. 2 also illustrates a typical method of reducing the effect of noise on digital and analog power supplies. The specific design will depend upon the MCU selected to practice the invention, printed circuit board layout, and other factors.

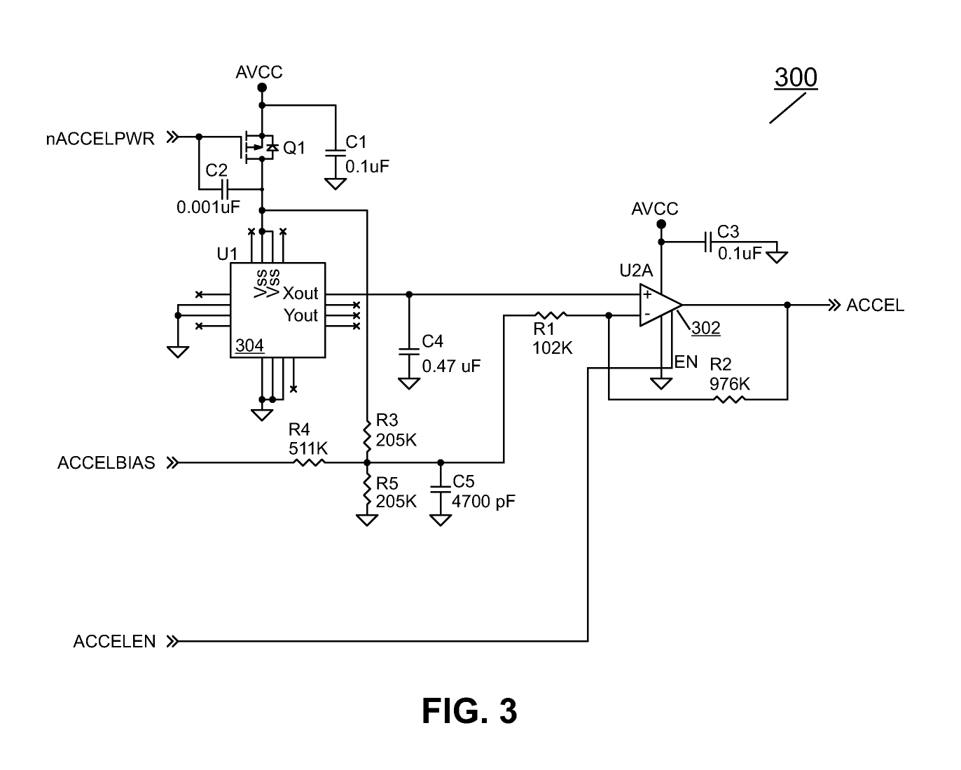

FIG. 3 illustrates details of one embodiment of accelerometer module 300. U1 304 is an integrated MEMS circuit that provides a voltage signal approximately linearly related to acceleration. Other accelerometers are available, such as piezoelectric, a ball bearing or mercury in a curved track, and such. Sensor U1 304 is mounted on the vessel, such that one axis (x-axis) of the accelerometer points in the direction of travel of the vessel. In this embodiment the x axis output signal is responsive to the forward acceleration of the vessel and the other output signal is responsive to roll. In the embodiment shown only the x axis is used. The accelerometer provides approximately AVCC/2 when there is no acceleration; that is, zero g. This is termed the “zero g bias voltage”. For the case of a positive acceleration due to a change in speed, the voltage will rise above the zero g bias voltage in proportion to the acceleration. Negative acceleration due to slowing of the vessel will produce a voltage below the zero g bias, again in proportion to the acceleration.

The output of U1 304 varies ratiometrically with the supply voltage. Zero acceleration provides an output of approximately half of the supply voltage, with some offset due to production variations. The resistor divider formed by R3 and R5 (FIG. 3) provides a bias voltage of half of the supply voltage. The bias and sensor outputs are compared and amplified by a differential amplifier U2A 302. The output of amplifier U2A 302 is also ratiometric and offset by half of the supply voltage. For example, with a 3V battery supply, the output will be approximately 1.5V for no sensed acceleration and will increase or decrease with positive or negative acceleration of the vessel.

Amplifier U2A 302 has a differential gain of about 5.8. The amplifier output terminal is connected to the ADC through the MUX of the MCU 200. The ADC input range also varies ratiometrically with supply voltage, therefore the resolution of acceleration by the system expressed in units of g per bit is constant, regardless of supply voltage.

Amplifier U2A 302 gain is selected to optimize the sensitivity of the circuit while allowing an acceptable range of minimum and maximum acceleration values. Since production variations of the range of output values in a given MEMS accelerometer can be significant, R4 and the ACCELBIAS signal are provided to modify the inverting amplifier U2A 302 terminal bias to accommodate accelerometer zero bias offsets. ACCELBIAS is driven by a tri-state output terminal of the MCU 200 and thus the output terminal may float or be driven to VCC or ground. When ACCELBIAS is floating, R4 will have no effect and the offset will be AVCC/2 as determined by R3 and R5. When ACCELBIAS is driven to ground, R4 will act in parallel with R5, providing a bias voltage of ( 5/12)*AVCC. Similarly, if ACCELBIAS is driven high, then the bias voltage will change to ( 7/12)*AVCC. This accommodates the full range of possible offsets specified for the accelerometer component used in the example shown.

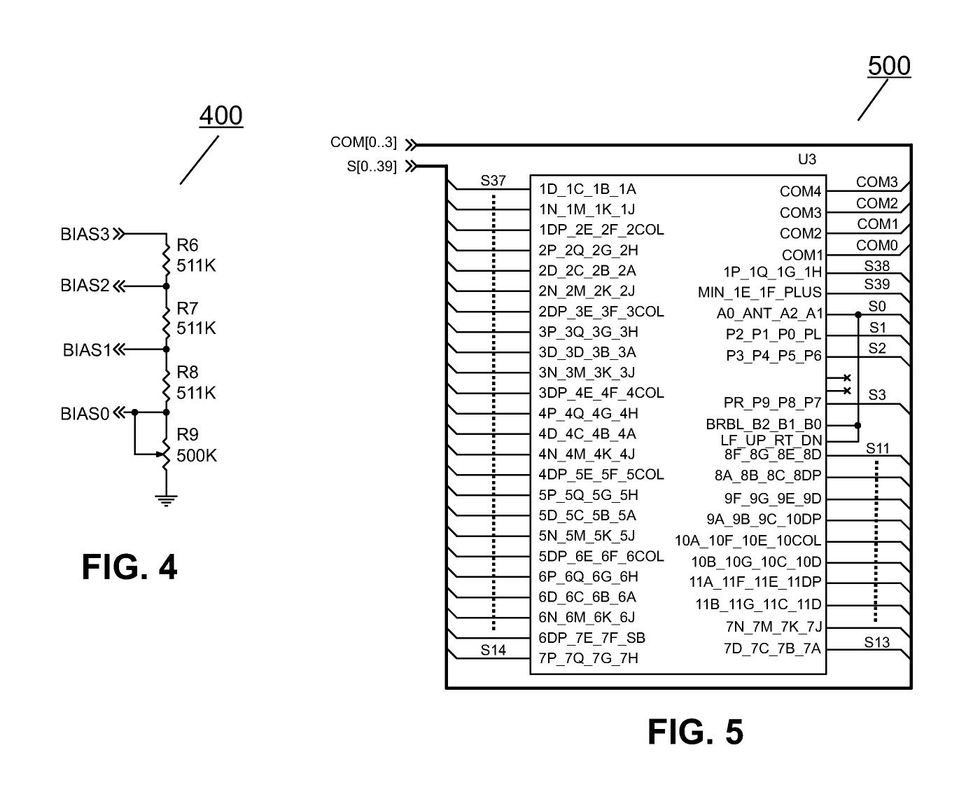

FIG. 4 shows details of LCD BIAS 400. The LCD driver integrated into the MCU 200 specifies four voltage levels to display viewable segments on an LCD. The LCD bias adjustment circuit provides the voltage levels through a simple voltage divider resistor ladder comprising resistors R6 to R9. Variable resistor R9 permits user adjustment of bias voltages to modify the LCD contrast and viewing angle, which may change due to temperature, battery voltage, or ambient light. In some embodiments R9 is replaced with a network of thermistors and other discrete components to provide automatic temperature and voltage compensation.

FIG. 5 shows connections from the MCU 200 to an LCD 500 with 40 segment lines and four common lines for a maximum of 160 individual display elements. Display elements may be arranged into numeric digits, bar graphics, symbols, and/or text characters. The MCU 200 controls display elements on the LCD to present information of interest to the user, such as vessel speed, distance traveled, time of day, vessel tilt, relative wind speed and wind pressure, or power and energy calculations such as calories per hour, accumulated calories consumed, power output in watts, and the like.

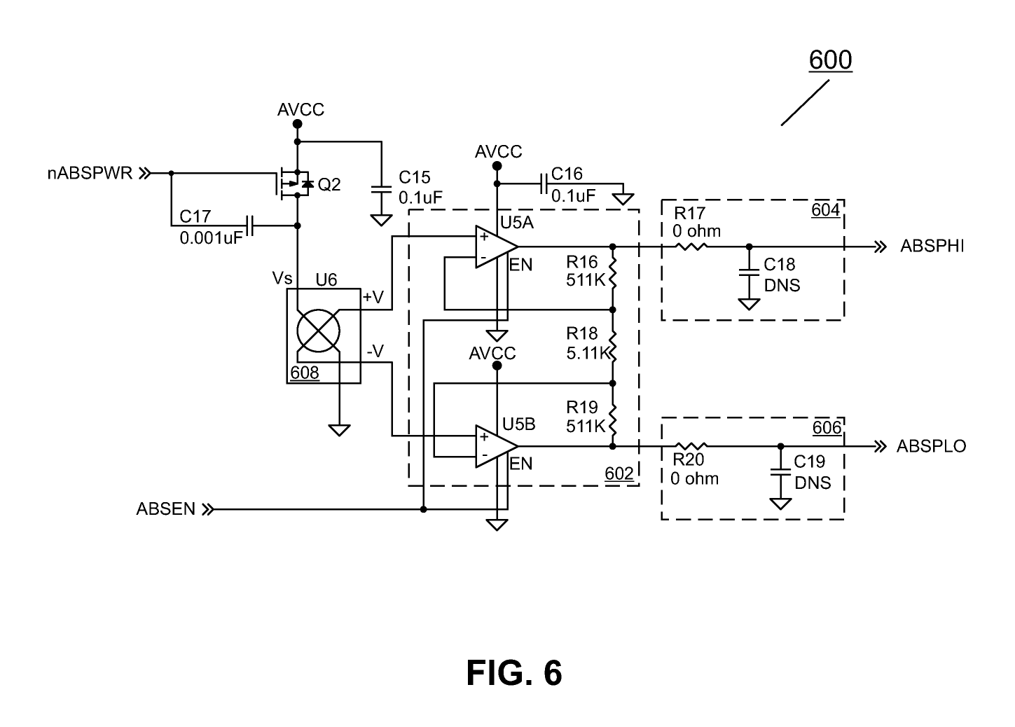

One embodiment of the present invention includes an absolute pressure module 600 to provide barometric pressure (Ps). FIG. 6 illustrates the schematic details. Updated barometric data is collected during a rowing event to recalculate air density, thereby providing corrected parameters for improved relative wind speed calculations. Air temperature is measured with an internal temperature sensor in the MCU 200, with an external temperature sensor, or may be entered by the user. In one embodiment, altitude information is provided by a GPS module (not shown).

Absolute pressure sensor U6 608 generates an approximately zero volt differential between sensor U6 output terminals +V and −V at zero pressure (complete vacuum), and a positive differential voltage for nonzero atmospheric pressures. As ambient pressure decreases in response to atmospheric changes, the differential output voltage from sensor U6 608 decreases. If the pressure rises, the differential voltage increases. The sensor U6 608 component selected must take into account the maximum and minimum pressure readings possible, functions of the maximum and minimum design attitude for the system. The barometric pressure is provided to pressure sensor U6 608 by air tight passages between the sensor and a hole in an enclosure, the hole oriented so as to be orthogonal to the direction of travel of the vessel. Alternatively, the static port of a pitot tube may be connected to pressure sensor U6 608 by an air tight passage.

The differential voltage across sensor U6 608 terminals +V and −V is applied to the high impedance inputs of differential amplifier 602, comprised of two operational amplifiers USA and U5B and resistors R16, R18, and R19. The difference of the output signals of operational amplifiers U5A and USB is approximately proportional to the difference of the inputs, with a gain of about 201 for the resistor values shown. The average of the two differential output voltages from differential amplifier 602 will be the same as the average of the inputs, equal to the common mode bias voltage of the sensor, typically near AVCC/2. Differential amplification causes one output to go up and the other to go down by equal amounts. If the differential input is zero, i.e., the two inputs are the same, the two outputs will also be the same. When pressure is applied the inputs will spread out, one going higher and one going lower from the common mode or average voltage of the two. As an example, given inputs of 1.501 and 1.499 (2 mV differential), with a gain of 201 the outputs would be 1.701 (1.5+201*001) and 1.299V. The output differential are 1.701-1.299=402 mV or 201 times the 2 mV input differential. The common mode voltage or average voltage of the two outputs are (1.701+1.299)/2=1.500V, same as the input.

RC low pass filters 604 and 606 remove high frequency noise from the outputs of differential amplifier 602. The filtered differential signals are connected with MCU 200 on lines ABSPHI and ABSPHLO. In some embodiments, low pass filters 604 and 606 are not used (that is, ABSPHI and ABSPLO are the unfiltered output of differential amplifier 602). In either case, digital signal processing firmware within the MCU 200 may also perform signal filtering.

In the example embodiment shown the differential voltage (ABSPHI−ABSPHLO) changes ratiometrically with battery supply voltage. Since the ADC input range also varies ratiometrically with battery supply voltage, the ADC count output will be approximately the same for a given pressure regardless of the supply voltage. In one embodiment the battery supply is regulated and the ADC is provided a reference voltage source.

MCU 200 calculates the absolute pressure by digitally sampling the signals on lines ABSPHI and ABSPLO and subtracting the two numerical values received from the ADC. The resulting difference is then scaled and corrected to take into account offsets and variations in circuit gain and sensor sensitivity as determined during calibrations.

The circuit for differential pressure module 700 is nearly identical to absolute pressure module 600. Differential amplifier 702 has a gain of 1820. Sensor U8 708 is connected with two pressure ports versus sensor U6 608, which is connected with one pressure port.

The following describes the operation and use of the differential pressure ports. For embodiments including an optional second set of sensors at the rear of the vessel, the operation is identical. Polling of the two differential pressure signals may be used to determine which set of sensors are to be used. The MCU 200 has been programmed to use one or the other sets of sensors, but not both at the same time. Differential pressure is used to measure the dynamic air pressure against the front of the vessel. Sensors measure the difference between two pressure input ports. The pressure input ports are holes in the system encasement which are connected with the pressure sensors by air tight passages. A first pressure input port faces the direction of travel and the air pressure (Pt) is connected to one side of pressure sensor U8 708 via an air tight passage. A second pressure input port is located on the side of the system encasement such that it receives static or atmospheric pressure (Ps). The atmospheric pressure is connected to a second side of pressure sensor U8 708 and to pressure sensor U6 608 by air tight passages. In some embodiments Pt and Ps are provide to the pressure sensor(s) by air tight passages connected to a pitot tube. Pressure sensor U8 708 senses the difference between the two pressure values, the difference being defined as “dynamic pressure” (Q), and is due to the movement of the vessel through the air. The total force against the vessel is related to the dynamic pressure, the drag coefficient, and the frontal area. That portion of total power required to move the vessel through the air is calculated based upon this force and the vessel speed.

In the embodiment shown sensor U8 708 includes two pressure input ports, sensing the differential pressure directly. In another embodiment a first sensor senses Ps and a second sensor senses Pt. The output signal of each sensor is connected to the ADC MUX. The ADC converts each of the two output signals separately and provides the digital result to the MCU 200. The MCU 200 calculates the dynamic pressure by subtracting Ps from Pt. Other configurations of differential pressure measurement are known to those skilled in the art.

According to Bernoulli's equation the dynamic pressure is

$$Q = ( {P}_{T} - {P}_{S} ) = \frac{ρ {V}^{2}}{2} .$$

Since the density of the air is known or can be estimated, the relative wind speed can be calculated from the dynamic pressure. Rearranging terms, we find the wind speed as:

$$V = \sqrt{\frac{2 * Q * RT}{{P}_{S}}} .$$

Since the pressure system has no knowledge of ground speed, this represents wind speed relative to the vessel.

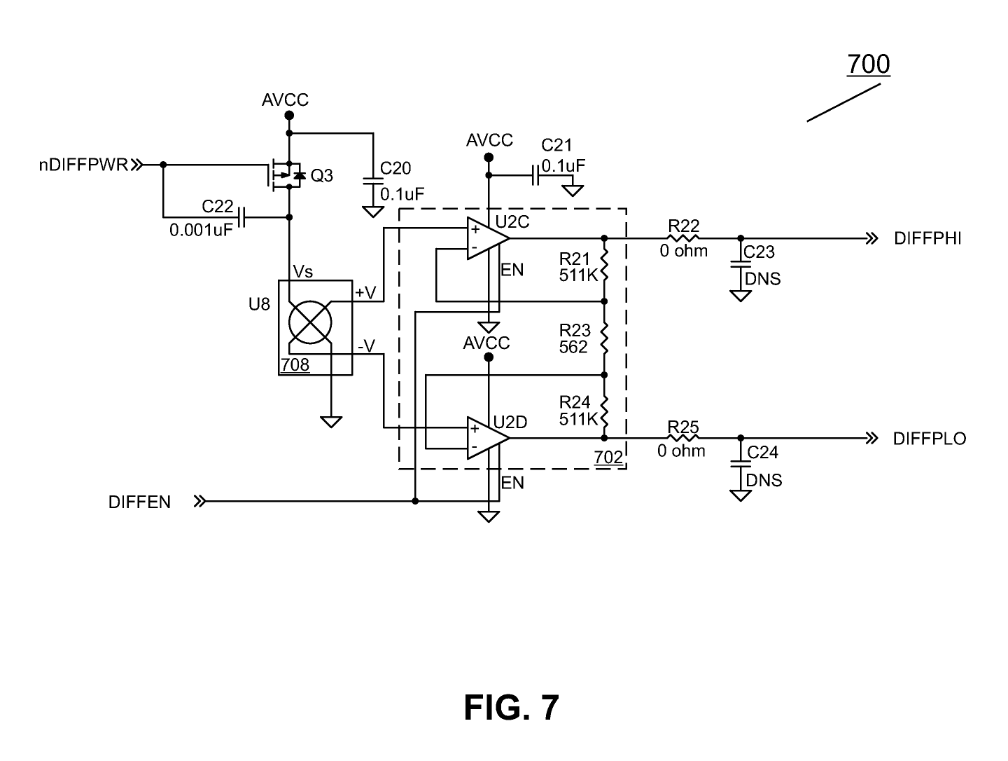

In one embodiment differential pressure module 700 is designed for operation over a pressure range of +/−10 kPa for good resolution of low pressure signals. The gain and sensitivity of differential pressure module 700 optimize the measurement range and measurement resolution over the expected range of vessel operating speeds. Using the configuration and values indicated in FIG. 7, differential pressure module 700 will measure air speeds of more than ninety mph without saturating amplifiers U2C and U2D. Other sensors and/or bias points may be selected for different operating ranges.

The MCU 200 digitally samples the signals provided by lines DIFFPHI and DIFFPLO and subtracts the two numerical values returned by the ADC conversions. The difference is scaled and corrected to take into account offsets and variations in circuit gain and sensor sensitivity as may be determined by calibrations.

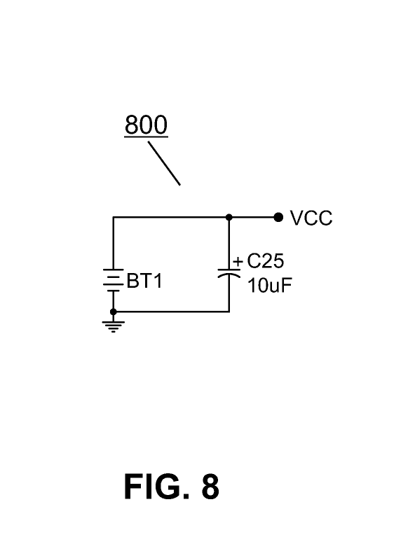

FIG. 8 details a typical battery supply 800. Other portable energy sources, such as solar power, may also be used.

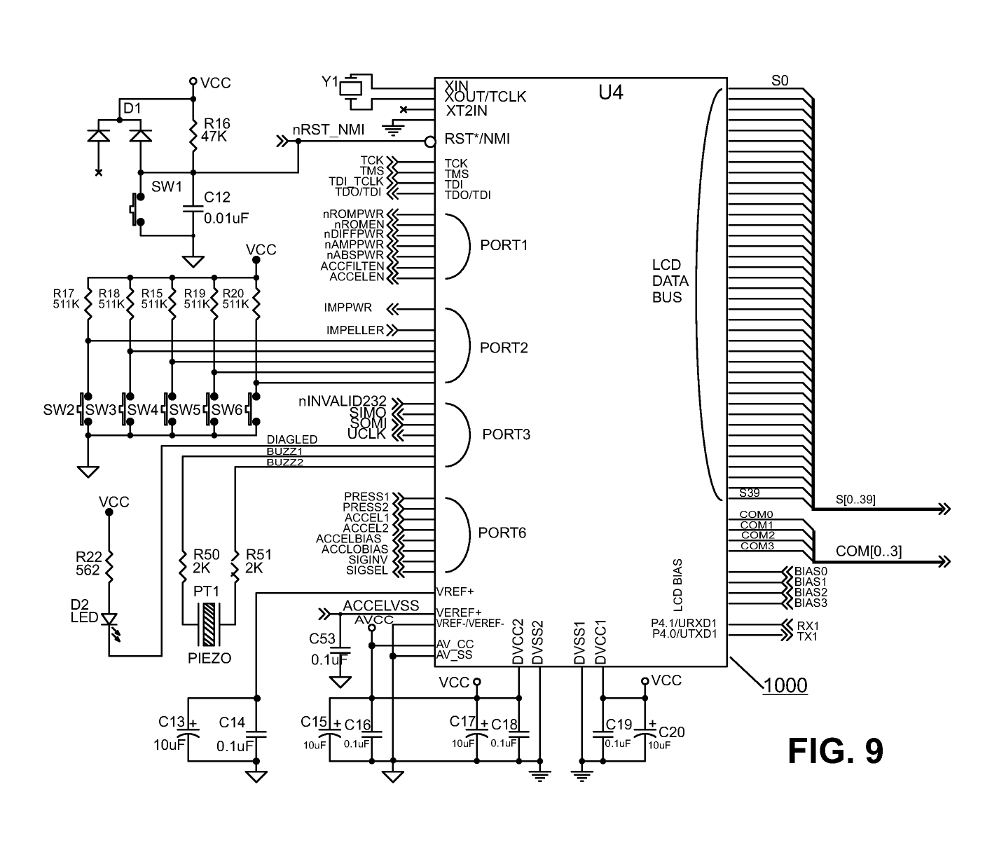

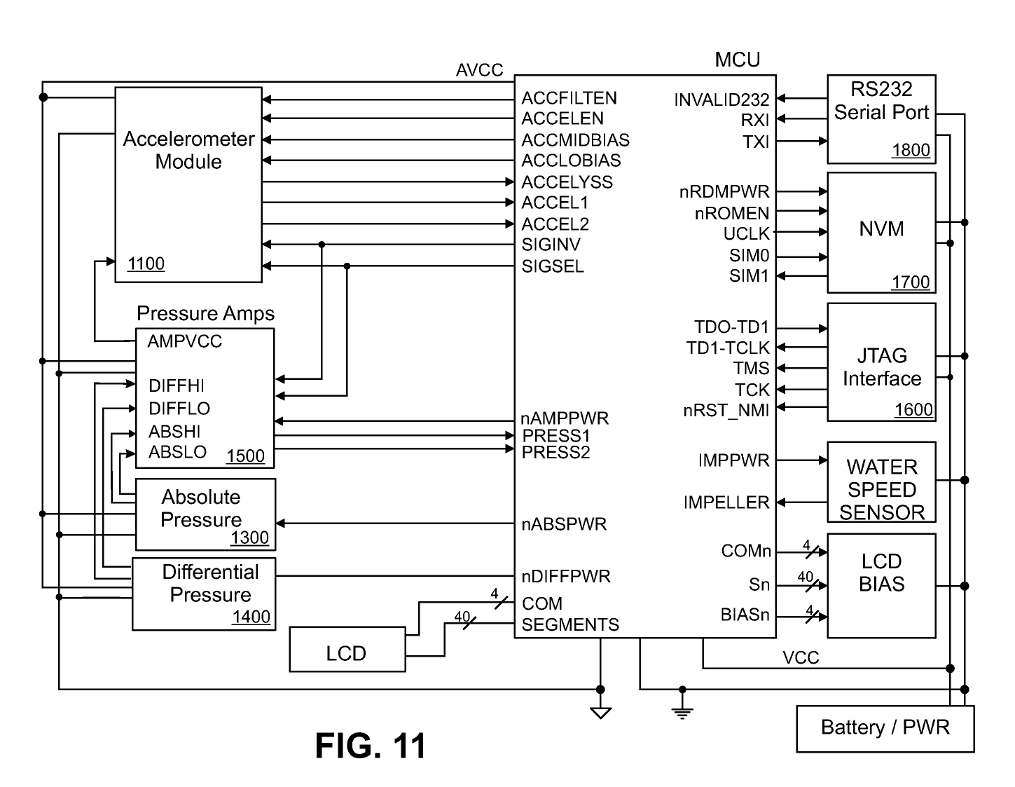

Connections between the functional blocks comprising another embodiment of the invention are shown in FIG. 11. FIG. 9 details circuit connections for the microcontroller in the embodiment of FIG. 11. LED D2 illuminates the display in low ambient light conditions. Piezoelectric buzzer PT1 provides audio feedback and may be used to alert the user to events or conditions such as a display screen change; meeting, exceeding, or missing a training range or goal; weather changes; suggested rowing cadence; or an alarm to deter theft.

Lines nROMPWR, NROMEN, SIMO, and UCLK connect MCU 1000 to a nonvolatile storage system 1700, such as that shown in FIG. 16. A nonvolatile storage system provides for storage of historical, event, calibration, customization, or other data to be saved when system power is turned off. In the embodiment shown in FIG. 16, a serial EEPROM is used as a nonvolatile storage device. Any nonvolatile storage solution, including battery backup or keep-alive of a volatile storage device, may be used.

Lines RX1, TX1, and nINVALID232 connect from MCU 1000 to an RS232 serial port 1800 of FIG. 17. The serial port provides for communications with an external computer or other external device for transfer of ride data, system setup, customization information, firmware updates, and other functions requiring data exchange with the MCU 200. Line nINVALID232 is asserted by transceiver U9 to indicate valid data is present on transceiver input lines. Transceiver U9 as shown in FIG. 17 is configured to remain on whether or not valid data is present on transceiver input lines. Connector 35 provides an optional DB9 interface for serial data communications with an external device. In other embodiments a USB, ANT+, or Bluetooth connection is used to communicate data. In one embodiment the invention is connected to a cell phone or PDA via a connector provided by the manufacturer for the transfer of data.

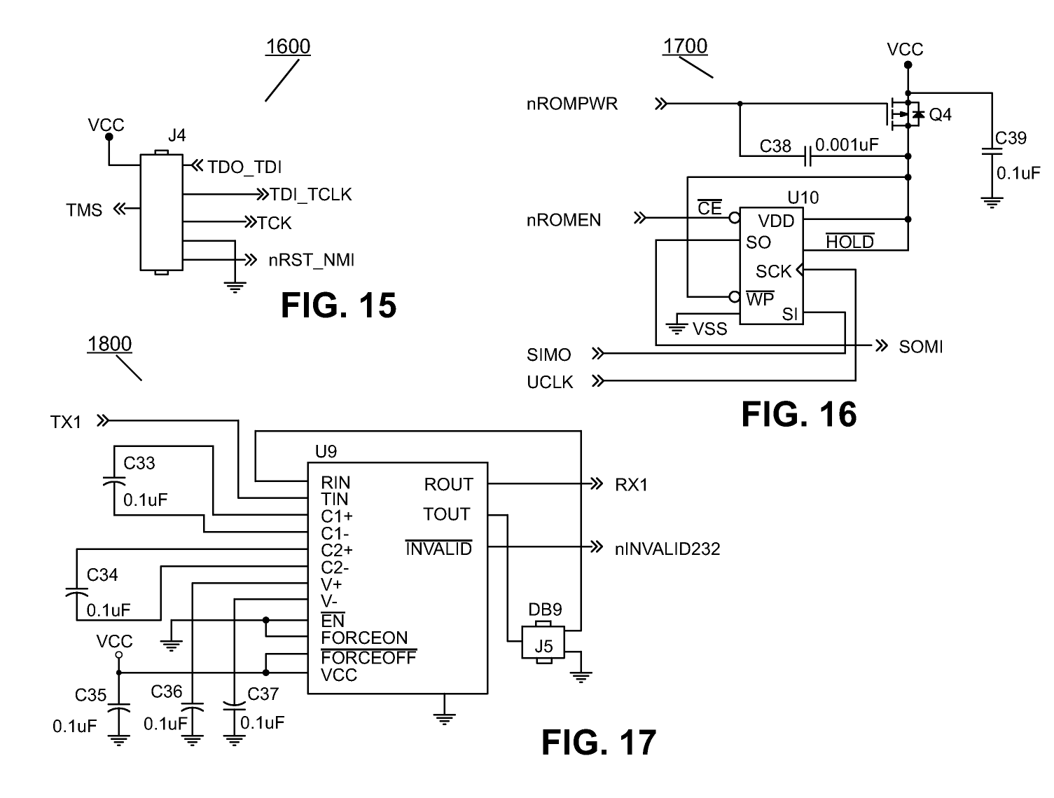

In one embodiment lines TDO/TDI, TDI_TCLK, TMS, TCK, and nRST/NMI connect MCU 1000 in FIG. 9 to connector 34 in a JTAG interface 1600 in FIG. 15. The JTAG interface via connector 34 provides means for MCU programming, testing, entering calibration values, or other operations. One skilled in the art will know of other methods for programming and testing. For example, the MCU may have external storage for constants, calibration, setup, or program storage.

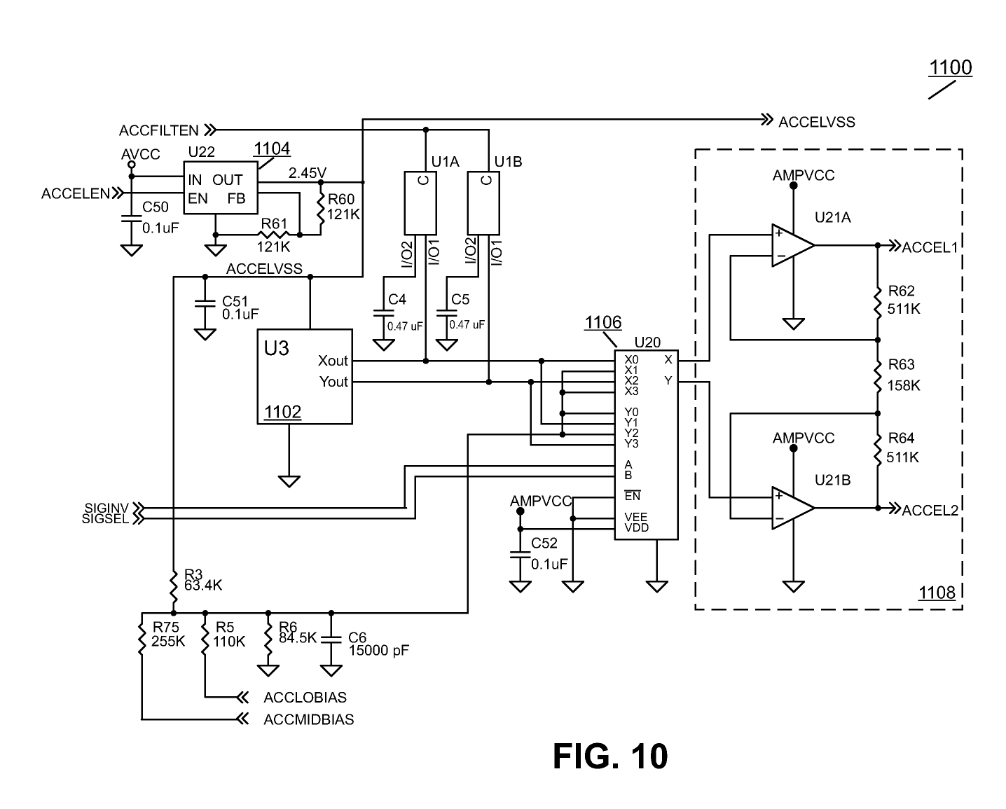

In one embodiment, both outputs of a dual-axis accelerometer are provided by acceleration module 1100, as shown in FIG. 10. The x-axis signal of accelerometer U3 1102 is used to determine forward acceleration of the vessel, including acceleration in response to gravitational forces, as previously described. In one embodiment the x-axis signal is used to determine power stroke cadence for rowing, sculling, or paddling. The instantaneous amount of forward acceleration is determined by the force applied by the rower. In general the rowing motion is periodic, a natural consequence of the rower(s) removing the paddle from the water at the end of the stroke, then moving the paddle towards the front of the vessel, then inserting the paddle into the water to begin a new stroke. The acceleration of the vessels changes instant-by-instant in response to the periodic motion of the paddle in the water, thereby providing data to determine the “cadence” of the rower through simple signal processing of the accelerometer signal.

A signal on line ACCELEN from MCU 1000 to the enable input terminal EN of voltage regulator U22 1104 in FIG. 10 turns power to the accelerometer on and off. Use of a voltage regulator diminishes changes in accelerometer sensitivity due to supply voltage changes. Line ACCELVSS, the regulated supply voltage output of U22, connects to a resistor divider network formed by R3, R75, R5, and R6. Lines ACCLOBIAS and ACCMIDBIAS are connected from MCU 1000 to the resistor divider and are individually controlled to float or be driven low to generate one of three different reference voltages. The MCU chooses the reference voltage which most closely matches the inherent zero g offset voltage of the particular sensor installed in the circuit, since zero g offset voltages may vary from part to part. A single reference voltage is used for both the x-axis and y-axis accelerometer channels, since only one axis is measured at a time. The reference voltage ACCELVSS also connects to the ADC voltage reference input of MCU 1000.

Dual 4:1 differential analog multiplexer U20 1106 decodes address signals SIGINV and SIGSEL to determine whether the x-axis or y-axis accelerometer signal from U3 1102 is connected as a differential signal to the inputs of differential amplifier 1102. The outputs of differential amplifier 1102, signals ACCEL1 and ACCEL2, are provided to an input port of the MUX to the internal ADC in MCU 1000. U20 1106 also functions as a commutating switch to swap input signals to differential amplifier 1102 for the purpose of nulling amplifier offset errors. To null amplifier offset errors, MCU 1000 first measures the difference between differential signals ACCEL1 and ACCEL2 while driven by either the x-axis or y-axis signal as selected by SIGINV and SIGSEL. SIGSINV and SIGSEL are then changed to swap the high side of the accelerometer differential signal pair with the low side. MCU 1000 again computes the difference between ACCEL1 and ACCEL2 and sums this value with the first difference computed for ACCEL1 and ACCEL2. The offset error present in the first difference is the same magnitude as the offset error in the second difference, but opposite in sign, so when the two differences are summed the offset errors cancel. The sum of the two differences is twice the value of the difference between ACCEL1 and ACCEL2 for an ideal amplifier with no offset error. This procedure is performed independently for the x-axis signal and the y-axis signal.

Signal ACCFILTEN in FIG. 10 enables a pair of bilateral switches U1A and U1B to connect low pass filters to the output lines of accelerometer U3 1102. Capacitors C4 and C5 form the low pass filters in conjunction with the internal resistance of the U3 1102 sensor outputs. Capacitance values are chosen to permit the filter to settle to less than ½ bit resolution for a 12-bit ADC in the time between consecutive samples. ACCFILTEN is controlled by MCU 1000 to disconnect the capacitors during accelerometer sensor power down, thereby conserving charge in the capacitors and reducing the next sample's settling time.

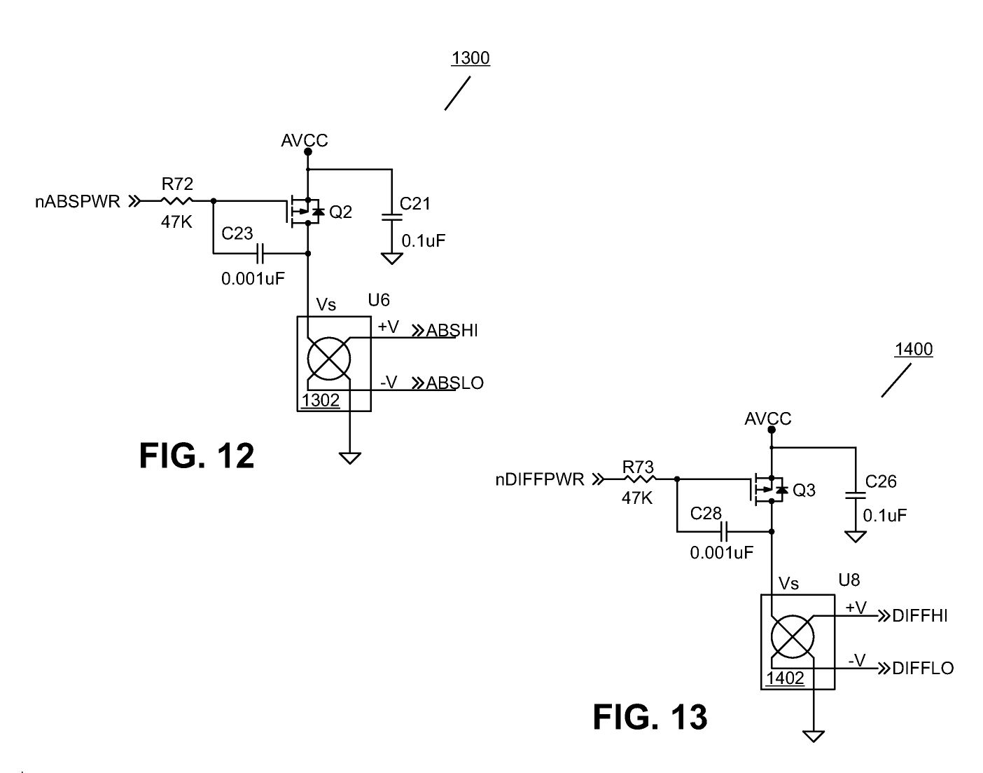

Pressure sensor connections are shown in FIG. 12 for an absolute pressure sensor module 1300 and FIG. 13 for a differential pressure sensor module 1400. In FIG. 12, signal nABSPWR enables power to sensor U6 1302. Sensor U6 1302 provides a differential signal approximately proportional to atmospheric pressure on lines ABSHI and ABSLO. Signal nDIFFPWR controls power to sensor U8 1402 in a similar manner as shown in FIG. 13. Sensor U8 1402 provides a differential signal approximately proportional to differential pressure on lines DIFFHI and DIFFLO. The absolute and differential pressure signals are presented unfiltered to amplifier block 1500.

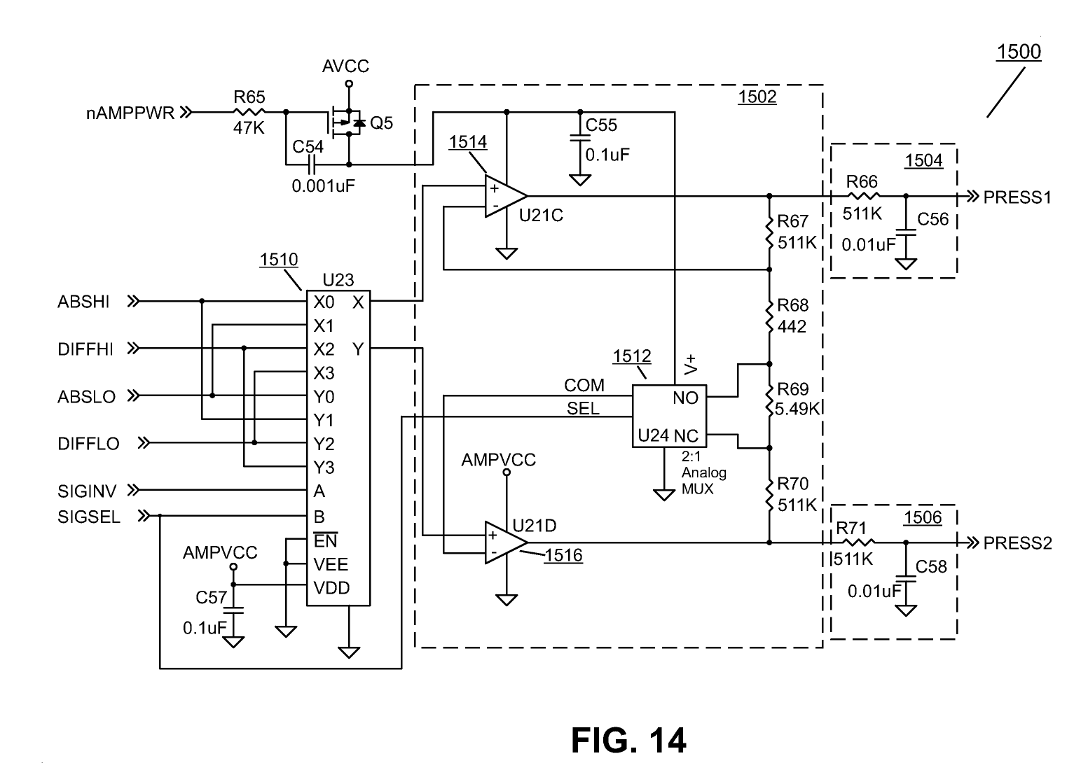

FIG. 14 illustrates an embodiment of an amplifier circuit wherein amplification of dynamic pressure signals and absolute pressure is provided. Only one mode of pressure (differential or absolute) is conditioned and measured at a time. Absolute pressure sensor lines ABSHI and ABSLO and differential pressure sensor lines DIFFI and DIFFLO are connected to separate sets of inputs on dual 4:1 analog differential multiplexer U23 1510. MCU 1000 controls address lines SIGINV and SIGSEL to select whether ABSHI and ABSLO or DIFFHI and DIFFLO are provided by multiplexer U23 1510 to differential amplifier 1502 inverting and noninverting inputs.

U23 1510 also functions as a commutating switch to swap input signals to differential amplifier 1502 for the purpose of nulling amplifier offset errors. MCU 1000 controls the swapping of inverting and noninverting inputs to amplifier 1502 and calculates the resulting differences between PRESS1 and PRESS2, similar to the method previously described for nulling amplifier errors in differential amplifier 1102.

Absolute and differential pressure sensors may have different sensitivities and therefore different amplifier gain requirements. 2:1 analog multiplexer U24 in FIG. 14 connects the noninverting input of one of the input stages with differential amplifier 1502 to one of two locations on the resistor network consisting of R67 to R70, thereby changing the effective overall differential gain of the amplifier. Gain is set to a high value when MCU 1000 drives line SIGSEL high. Gain is set to a lower value when MCU 1000 drives line SIGSEL low. Values of resistors R67 to R70 are chosen such that the differential gain of amplifier 1502 is approximately 2,300 for the differential pressure sensor and approximately 175 for the absolute pressure sensor. The differential output signals of amplifier 1502 pass through low pass filters 1504 and 1506 and are then connected to lines PRESS1 and PRESS2. Lines PRESS1 and PRESS2 are connected with an input port for the internal ADC in MCU 1000.

MCU 1000 turns power to amplifier 1500 on and off by controlling line nAMPPWR. Asserting a signal on line nAMPPWR turns on power to multiplexers U23 1510 and U24 1512 and operational amplifiers U21C 1514 and U21D 1516.

In one embodiment some sensor circuits are calibrated to improve the overall accuracy of the systems. Gain and offset values for pressure, acceleration, and temperature sensors are determined by a calibration method comprising exposing the system to two or more controlled pressures, accelerations, and temperatures respectively. For pressure and acceleration the no-pressure (vacuum) and no-acceleration (at rest) conditions are determined by calculations extending the calibration data to find the “zero offset” values. The results of calibrations are ADC readings which are stored in memory. One may optionally calibrate to more conditions and determine a calibration curve throughout the operating range of a sensor. A lower cost system with less accuracy may use one point for calibration or no calibration but rather component datasheet and design values.

Other information is needed by the system. For example, the user may enter the weight of the vessel plus himself and any other occupants, the oars, and all other equipment. In some embodiments the system is updated for such factors as ambient pressure, altitude, or temperature by user entry.

In some embodiments we estimate an average water skin friction and a scale factor relating frontal area and drag coefficient to dynamic pressure. These values are improved upon in one embodiment by a “coast-down calibration” procedure. The vessel is accelerated until it attains a certain minimum (high) speed for example, 8 mph, then all rowing, paddling or other power input is stopped, letting the vessel coast down to a predetermined maximum (low) speed, for example, 2 mph, while the occupants maintain their typical positions, holding the oar(s) or paddle(s) out of the water. During the coast-down period the system records readings to be used by a curve fitting technique. The curve fitting step is done to determine dynamic wind and water skin resistance forces. The aerodynamic factor is the overall constant relating Q to drag force. The aerodynamic factor is found by the product:

Aerodynamic drag=(drag coefficient)*(frontal area),

though neither is known separately. The water skin resistance is the product of a constant and the square of the water speed of the vessel.

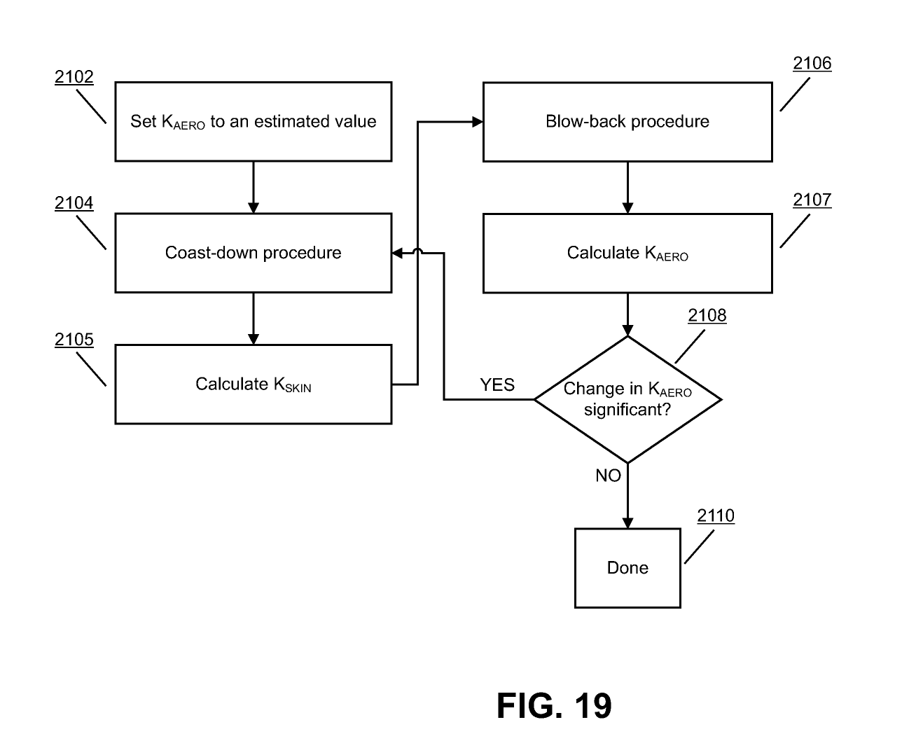

The calibration method is further described by FIG. 19, which illustrates the process of iteratively calibrating K_{AERO} and K_{SKIN}. The process begins 2102 with an estimated value for K_{AERO}. The coast-down procedure 2104, using the estimated value of K_{AERO}, finds a value 2105 for K_{SKIN}. The value of K_{SKIN} is then used in the blow-back calibration procedure 2106, resulting in a new value for K_{AERO}. The new value of K_{AERO} is compared 2108 to the previous value for K_{AERO}. If the change is significant, for example greater than ten percent, the newly determined value for K_{AERO} is then used in another coast-down step 2104, then a new K_{AERO} value found 2107, and again the instant value of K_{AERO} is compared 2108 to the previous value for K_{AERO}. When the change in K_{AERO} is found to be small, then the process exits 2110 with calibrated values for K_{AERO} and K_{SKIN}. In one embodiment the processes of coast-down and blow-back are only done once and the data stored, then the process from step 2108 comprises the steps of 2105, 2107, and 2108; that is, only the data is manipulated, not another physical calibration step. However actually redoing the calibration steps may improve the quality of the data by providing additional data point.

Consider an example of applying the method of the present invention to the disclosed apparatus to determine the power expended when rowing or paddling against a rapid current. Even if the vessel makes no progress relative to land, since the water speed is used for calculating the water skin drag, the invention would show that the rower or paddler is expending energy during the workout. In some embodiments, additional energy losses are measured and taken into account for calculating the power supplied by the rower. Using Newton's Third Law, the equation of motion for a vessel on water is:

F_{Toral}=F_{Skin}+F_{Aero}+F_{Acceleration}.

The forces due to other sources of water drag, such as wave or hull form resistance, are small for racing hulls and may be ignored. The portion of the drag force due to aerodynamic resistance is:

F_{Aero}=0.5*(C_{D}AρV_{Air}²),

where Cd is the coefficient of drag, A is the cross-sectional area, ρ is air density, and Vₐᵢᵣ is the velocity of the vessel relative to air. The power required to propel the vessel can be obtained by multiplying F_{Total} by the speed of the vessel relative to the water, V_{water}. Further, the power associated with each term in the equation of motion can be calculated by multiplying by V_{Water}.

However, beyond the power need to propel the vessel, additional power must be delivered by the rower to overcome other sources of loss beyond the sources of loss in the equation of motion. For example, if the vessel in a body of still water were pointed into a stiff headwind and the rower were only rowing fast enough to keep the vessel still and not be blow backwards by the wind, the rower supplies rowing power even though F_{Total} equals zero for the equation of motion. This is because the rowing propulsion process creates turbulence, and therefore heat. That is, the propulsion mechanism is lossy and in the example all of the rower power goes into that loss mechanism. With the sensors available in the present invention, part of that loss can be accounted for, specifically:

Thermodymanic Loss=F_{Aero}*(V_{Air}−V_{Water})

This is a portion of the power that does not contribute to the equation of motion, but does result in thermodynamic energy loss in the system. In some embodiments of this invention, this power loss is included in the calculation of power supplied by the rower.

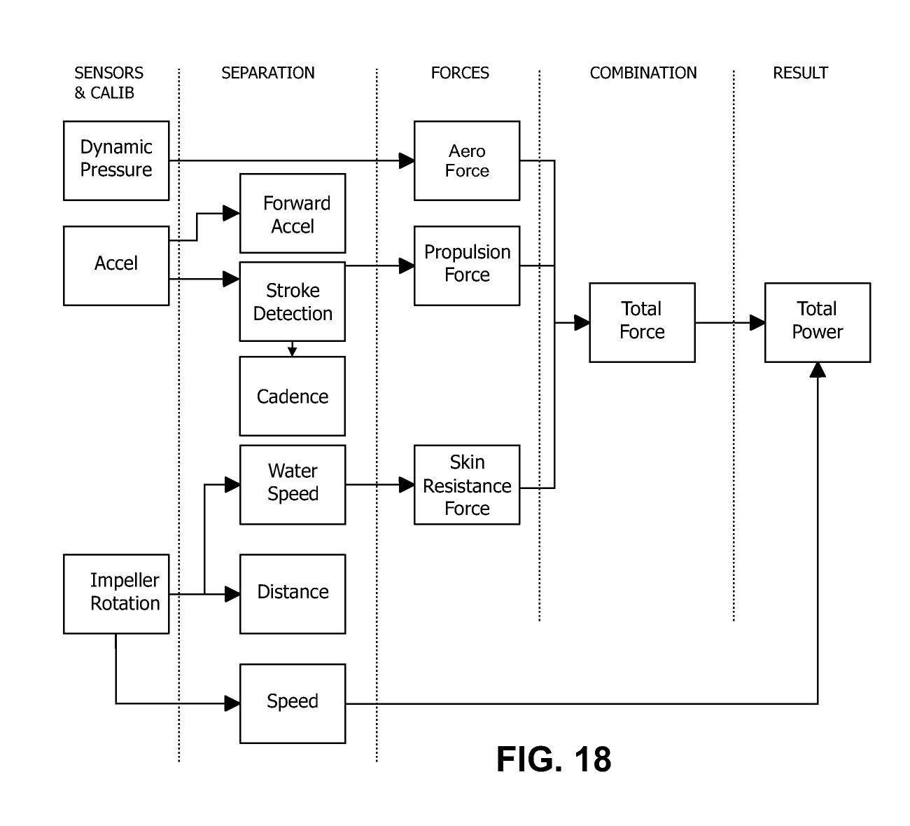

Firmware in the MCU processes sensor, timing, scale and calibration data to determine, record, or present certain information to the viewer. FIG. 18 is a conceptual presentation of the logical flow of the firmware. In the section labeled “Sensors”, instant absolute pressure, differential pressure, and acceleration sensor readings are taken. Any calibration or scale factors are taken into account (not shown).

Appendix II presents one embodiment of firmware for using the (adjusted) sensor readings, referred to in FIG. 18 as the “Separation” section. Impeller rotation data is used to determine water speed. The accelerator signal is used to measure the rowing cadence and to mark the start time of each strock so that power per stroke, stroke count, stroke cadence can be determined and recorded. In some embodiments GPS data is used to determine to accumulated distance with respect to land. Any change in rotation rate of the impeller is used to determine forward acceleration relative to the water, which is then subtracted from the accelerometer data to determine the gravity force contribution in the case of rapidly flowing, non-level water. As previously described, data resulting from other means for determining water speed may be used instead of impeller rotation timings. In the section labeled “Forces”, detailed in Appendix III, three force elements are determined. In the “Combination” section (also included in Appendix III) the three forces (aerodynamic drag, change in altitude, water skin resistance, and acceleration) are combined.

Finally, per the “Result” section of FIG. 18, total force is multiplied by vessel speed through the water to yield total power.

The pseudocode presented in the appendices is for illustration purposes. One skilled in the art would be able to develop code for any suitable MCU using any suitable programming language from the pseudocode.

One skilled in the art will recognize from the above that the present invention can be extended to any number of different combinations or subsets of sensing, computing, and storage elements. Accordingly, the present disclosure is to be taken as illustrative rather than as limiting the scope, nature, or spirit of the subject matter claimed below. Numerous modifications and variations will become apparent to those skilled in the art after studying the disclosure, including use of equivalent functional and/or structural substitutes for elements described herein, use of equivalent functional couplings for couplings described herein, and/or use of equivalent functional steps for steps described herein. Such insubstantial variations are to be considered within the scope of what is contemplated here. Moreover, if plural examples are given for specific means, or steps, and extrapolation between and/or beyond such given examples is obvious in view of the present disclosure, then the disclosure is to be deemed as effectively disclosing and thus covering at least such extrapolations.

### Reservation of Extra-Patent Rights, Resolution of Conflicts, and Interpretation of Terms

After this disclosure is lawfully published, the owner of the present patent application has no objection to the reproduction by others of textual and graphic materials contained herein provided such reproduction is for the limited purpose of understanding the present disclosure of invention and of thereby promoting the useful arts and sciences. The owner does not however disclaim any other rights that may be lawfully associated with the disclosed materials, including but not limited to, copyrights in any computer program listings or art works or other works provided herein, and to trademark or trade dress rights that may be associated with coined terms or art works provided herein and to other otherwise-protectable subject matter included herein or otherwise derivable herefrom.

Unless expressly stated otherwise herein, ordinary terms have their corresponding ordinary meanings within the respective contexts of their presentations, and ordinary terms of art have their corresponding regular meanings.

```
//-------------------------------------------
// © COPYRIGHT 2009 VELOCOMP, LLP
// ALL RIGHTS RESERVED
//-------------------------------------------
// Global variables
//-------------------------------------------
// Sensor readings, converted and scaled
Temperature; // degrees C
DynamicPressure; // Pascals = 1/1000 kPa
AccelerometerGs; // g from the accelerometer
// Derived values
TiltAngle; // fore/aft tilt angle of vessel
FwdAccelGs; // g of forward acceleration
Distance; // meters
ImpellerRevs; // impeller revolutions
WaterSpeed; // vessel speed, meters/sec
//-------------------------------------------
// Stored coefficients and calibration values
//-------------------------------------------
TotalMass; // Vessel and rower Kg, entered by rower
// Aero constant combines frontal area and drag coefficient
Kaero; // Newtons/Pascal, from calibration
// Skin drag constant (Skin drag force) / (water speed)\hat{ }2
Kskin; // kg/m, from calibration
// Constants
Kgravity = 9.81; // Gravitational acceleration, m/sec\hat{ }2
// Estimated aero constant for initial calibration calculation
Kaero_est = 0.8 // Newton/Pascal for a single-man rowing hull
//*******************************************************
// CALIBRATION PROCEDURES
//*******************************************************
// TILT CALIBRATION BY USER
//*******************************************************
// This determines the true angle of the accelerometer when the vessel is
// is floating in calm water and loaded with all passengers and equipement
TiltCal( ) {
  // Tell user to hold vessel still
  Message(“Hold Still”);
  LevelAngle = arcsin(AccelerometerGs);
}
//*******************************************************
//  COAST-DOWN CALIBRATION PROCEDURE
//*******************************************************
// Coast-down procedure to determine water skin resistance using an
// estimated value of aerodynamic drag, Kaero_est. The value of Kaero
// can be measured later in the blow back procedure. Both values can be
// improved by repeating both procedures.
// The vessel is allowed to coast from a high to a low speed while force and
// sensor data is collected. The missing coefficients are then derived by
// fitting a straight line to the collected data after reducing it to linear form.
CoastDown( ) {
  // If the unit has not yet been calibrated, set Kaero to the Kaero_est value
  // according to the vessel type and configuration
  If (uncalibrated)
    Kaero = Kaero_est
  // Tell user to reach HighSpeed
  while (Speed < HighSpeed)
    Message(“Go Faster”);
  Message(“Coast”); // tell user to stop rowing
  // Fill an array of data samples
  // The model is:
  // TotalForce = Faero( ) + Fskin( ) + Faccel( ) = 0 while coasting
  // If the device has been properly leveled, then we can calculate
  // Faccel( ), but we are still missing the water skin drag force.
  // The equation of motion can be rearranged to the equation of a line
  // −Faero( ) − Faero( ) = Fskin( ) = Kskin * WaterSpeed\hat{ }2
  // where
  //  Y: −Faccel( ) − Faero( )
  //  X: WaterSpeed\hat{ }2
  //  slope: Kskin
  //  intercept: =
  // So we just need to record the total of known forces, the
  // DynamicPressure, and the water speed at each data point.
  // Fitting the best straight line (constrained to go through the origin)
  // to the resulting data gives us Kskin.
  // Three parallel arrays, one for total known forces, one for pressure
  // and one for water speed.
  DynPress[ ];
  OtherForces[ ];
  WSpeed[ ];
  i = 0;
  while (WaterSpeed > LowSpeed) {
    DynPress[i] = DynamicPressure;
    OtherForces[i] = −(Faccel( ) + Faero( ));
    i = i + 1;
  }
  // Low speed reached, tell user to stop.
  Message(“Done Coast”);
  // Process the data using linear regression
  // Best fit for y(x) = ax + b is derived by:
  //  Define:
  //  Sx = sum(x)
  //  Sy = sum(y)
  //  t(i) = x(i) − Sx/N = x(i) − Avg(x)
  //  Stt = sum(t\hat{ }2)
  //  Sty = sum(t*y)
  //  where the sums are taken over all N points
  // then:
  //  b = Sty/Stt
  //  a = (Sy − b * Sx) / N
  //
  DataPoints = i;
  i = 0;
  Sx = 0;
  Sy = 0;
  while (i < DataPoints) {
    Sx = Sx + DynPress[i];
    Sy = Sy + OtherForces[i];
    i = i + 1;
  }
  AvgPress = Sx / DataPoints;
  i = 0;
  Stt = 0;
  Sty = 0;
  while (i < DataPoints) {
    t = DynPress[i] − AvgPress; // no need for an array of t
    Stt = Stt + t * t;
    Sty = Sty + t * OtherForces[i];
    i = i + 1;
      }
  Kskin = (Sy − Froll * Sx) / DataPoints;
}
//*******************************************************
// BLOW-BACK CALIBRATION PROCEDURE
//*******************************************************
// Blow-back procedure to determine aerodynamic resistance using the value
// of Kaero measured in the previous coast-down procedure. The resulting
// value of Kaero can then be used in another coast-down procudure to
// improve the measurement of Kskin.
// The vessel is pointed into a headwind and then the vessel is allowed to be
// blown backwards by the wind until the vessel reaches terminal velocity.
// In this case, the wind force is equal and opposite to the water skin drag.
// TotalForce = Faero( ) + Fskin( ) + Faccel( ) = 0 while coasting
// Further, Faccel( ) = 0.
//
// Faero( ) = −Fskin( )
// which reduces to
// Kaero = Kskin*avg(WaterSpeed\hat{ }2)/avg(DynamicPressure)
// where the backwards water speed is taken as a positive number.
BlowBack( ) {
  // Tell user to orient into the wind
  while (Speed < HighSpeed)
    Message(“Point into wind”);
  Message(“Coast”);  // tell user to stop rowing
  // Fill an array of data samples once at terminal speed
  DynPress[ ];
  WSpeedSq[ ];
  i = 0;
  while (WaterSpeed > LowSpeed) {
    DynPress[i] = DynamicPressure;
    WSpeedSq[i] = WaterSpeed\hat{ }2;
    i = i +1;
  }
  // 20 seconds after terminal blow back speed reached,
  // tell user to stop.
  Message(“Done Blow-Back”);
  DataPoints = i;
  i = 0;
  while (i < DataPoints) {
    AvgDynPress = AvgDynPress + DynPress[i];
    AvgWSpeedSq = AvgWSpeedSq + WSpeedSq[i];
    i = i + 1;
  }
  AvgDynPress = AvgDynPress / DataPoints;
  AvgWSpeedSq = AvgWSpeedSq / DataPoints;
  Kaero = Kskin * AvgWSpeedSq / AvgDynPress
}
APPENDIX II
//-------------------------------------------
// © COPYRIGHT 2009 VELOCOMP, LLP
// ALL RIGHTS RESERVED
//-------------------------------------------
//*******************************************************
//  FORCE AND POWER CALCULATIONS
//*******************************************************
// Total force calculation, Newtons
Ftotal( ) { return (Faero( ) + Fskin( ) + Faccel( )); }
// Aerodynamic force calculation, Newtons
Faero( ) { return Kaero * DynamicPressure; }
// Water skin drag force, Newtons
Fskin( ) { return Kskin * WaterSpeed * WaterSpeed; }
// Forward acceleration force calculation, Newtons
Faccel( ) { return TotalEffMass * FwdAccelGs; }
Watts( ) { return Ftotal * WaterSpeed; }
```

What is claimed is:

1. An apparatus for sensing forces upon a vessel floating on water, the apparatus comprising:
a microcontroller (“MCU”), including electronic ports for receiving digital and analog signals;
an analog to digital converter (“ADC”), including an analog input port, the ADC converter providing to an input port of the MCU a digital version of a signal electronically connected to the ADC analog input port;
a MUX with multiple selectable analog input ports and an analog output port, the output port of the MUX connected to the analog input port of the ADC whereby a signal on a MUX input port selected by the MCU is electronically connected to the input port on the ADC on a line;
a plurality of analog sensors, the output signal of each analog sensor independently connected to a predetermined analog input port of the MUX, wherein the plurality of analog sensors comprises one or more differential pressure modules responsive to differential pressure, and an acceleration module responsive to acceleration in the direction of travel of the vessel;
means for detecting speed of water flowing past the vessel in the direction of motion of the vessel electronically connected to the MCU on a line;
an enclosure enclosing the apparatus, rigidly connected to the vessel, wherein the enclosure includes a first and a second hole, each hole connected to an air tight passage to a corresponding pressure sensor, wherein the first hole provides static air pressure and the second hole provides total air pressure; and
an electrical power source providing electrical power to the apparatus.

2. The apparatus of claim 1, further comprising an electronic memory system for storing data, wherein the memory system is connected to the microcontroller.

3. The apparatus of claim 1, further comprising an electronic memory system for storing data, wherein the memory system is integrated within the microcontroller.

4. The apparatus of claim 1, further comprising a display system, electronically connected to a display driver in the MCU.

5. The apparatus of claim 4, wherein the display system comprises a liquid crystal display device.

6. The apparatus of claim 4, wherein the display system comprises an LED display.

7. The apparatus of claim 1, wherein the ADC is integrated within the MCU.

8. The apparatus of claim 1, wherein the MUX is integrated within the MCU.

9. The apparatus of claim 1, wherein the power source is a battery.

10. The apparatus of claim 1, wherein the power source is a solar array.
